(19) United States
(12) Patent Application Publication
(10) Pub. No.: US 2024/0134444 A1
(43) Pub. Date: Apr. 25, 2024

(54) DISPLAY APPARATUS, DISPLAY METHOD, AND COMPUTER READABLE MEDIUM

(71) Applicant: Asahi Kasei Microdevices Corporation, Tokyo (JP)

(72) Inventors: Shota ISSHIKI, Tokyo (JP); Takaaki FURUYA, Tokyo (JP)

(21) Appl. No.: 18/483,528

(22) Filed: Oct. 10, 2023

(30) Foreign Application Priority Data
Oct. 12, 2022 (JP) 2022-163762

(51) Int. Cl. G06F 3/01; F24F 11/00; F24F 11/523; F24F 11/56; F24F 11/80; G08B 21/14

(52) U.S. Cl. CPC G06F 3/011; F24F 11/0008; F24F 11/523; F24F 11/56; F24F 11/80; G08B 21/14; F24F 2110/10

(57) ABSTRACT

To provide a display apparatus including a display part which displays an image of a virtual space, and a transmitting part. The display part further displays state information relating to a state of a reality space where an operator of the display part is present, and the transmitting part transmits, to control equipment which controls the state of the reality space, control information for controlling the state of the reality space. The display apparatus may further include a sensing part. The display part may further display a virtual input image in the virtual space. The transmitting part may transmit, when input to the virtual input image is sensed with the sensing part, the control information to the control equipment.

The contents of the following patent application(s) are incorporated herein by reference: NO. 2022-163762 filed in JP on Oct. 12, 2022

### TECHNICAL FIELD

The present invention relates to a display apparatus, a display method, and a computer readable medium.

### BACKGROUND

Patent document 1 describes, “(a)n electronic device providing information through a virtual environment is disclosed” (Abstract). Patent document 2 describes, “a head-mounted display which allows an observer himself/herself to measure the timing to turn off power is provided” (Abstract).

### PRIOR ART DOCUMENT

### Patent Document

Patent Document 1: U.S. Pat. No. 11,120,630
Patent Document 2: Japanese Patent Application Publication No. 2012-212990

### BRIEF DESCRIPTION OF THE DRAWINGS

FIG. 1 shows an example of a reality space 300.

FIG. 2 shows an example of an image of a virtual space 400.

FIG. 3 is a block diagram showing an example of a display apparatus 100 according to one embodiment of the present invention.

FIG. 4 shows another example of the display apparatus 100.

FIG. 5 shows another example of the reality space 300.

FIG. 6 shows another example of the image of the virtual space 400.

FIG. 7 shows an example of a control system 200.

FIG. 8A shows another example of the reality space 300.

FIG. 8B is a schematic view illustrating a vicinity of an ear 112 of an operator 110.

FIG. 9 shows examples of the reality space 300 and surroundings of the reality space 300.

FIG. 10 is a flowchart including an example of a display method according to one embodiment of the present invention.

FIG. 11 shows an example of a computer 2200 in which the display apparatus 100 according to one embodiment of the present invention may be entirely or partially embodied.

### DESCRIPTION OF EXEMPLARY EMBODIMENTS

Hereinafter, the present invention will be described through embodiments of the invention, but the following embodiments do not limit the invention according to claims. In addition, not all of the combinations of features described in the embodiments are essential to the solution of the invention.

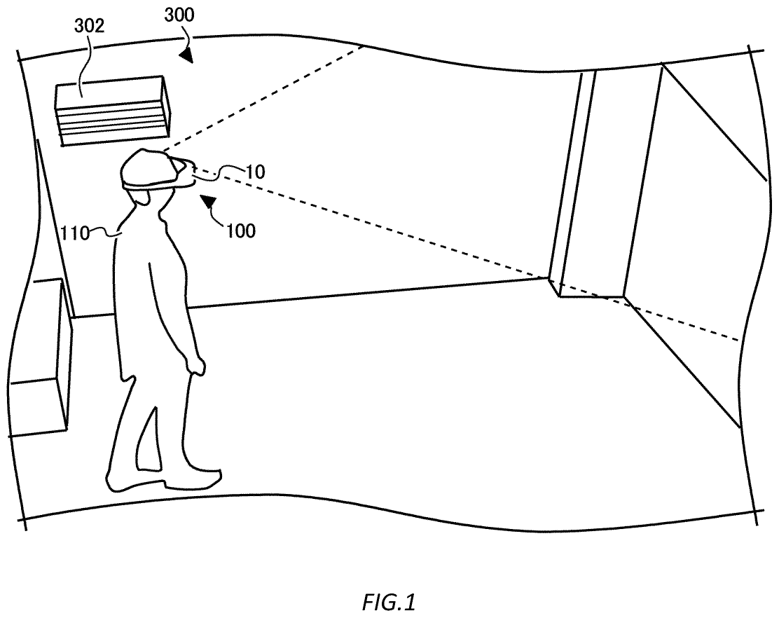

FIG. 1 shows an example of a reality space 300. The reality space 300 of the present example is a room. An operator 110 is present in the reality space 300. The operator 110 is a living body. The operator 110 of the present example is a human.

Control equipment 302 controls a state of the reality space 300. The control equipment 302 may be arranged in the reality space 300. The control equipment 302 is, for example, air-conditioning equipment (an air conditioner), an air cleaner, a humidifier, a dehumidifier, a ventilation system, or the like. The state of the reality space 300 may refer to a state of an atmosphere in the reality space 300. In the present example, the atmosphere in the reality space 300 refers to air in the reality space 300.

A display apparatus 100 includes a display part 10. The display apparatus 100 may be a wearable terminal worn by the operator 110. The display part 10 may be a Virtual Reality (VR) goggle. The display apparatus 100 may also be a wearable terminal of a head-mounted display (HMD) system. The operator 110 operates the display part 10.

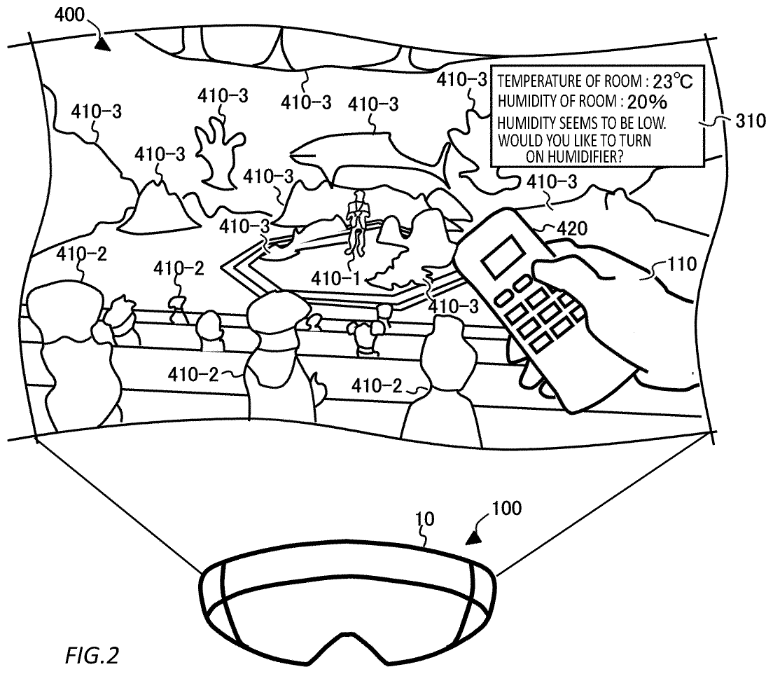

FIG. 2 shows an example of an image of a virtual space 400. The display part 10 displays the image of the virtual space 400. The image of the virtual space 400 is an image of a virtual reality. This image is an image which is visually recognized by the operator 110 (see FIG. 1).

The image of the virtual space 400 may include virtual objects 410. The virtual objects 410 are objects which do not exist in the real world. In the present example, the image of the virtual space 400 includes three kinds of virtual objects 410. In the present example, a virtual object 410-1 is a singer, a virtual object 410-2 is an audience, and a virtual object 410-3 is a rocky area or the like. In the present example, the operator 110 simulatively experiences a concert by visually recognizing the image of the virtual space 400.

The display part 10 further displays state information 310. The state information 310 is information relating to the state of the reality space 300. The state information 310 may be information representing the state of the reality space 300. In the present example, the state information 310 is information on a temperature or a humidity of the reality space 300. The state information 310 may also be information on a state outside of the reality space 300 which relates to the state of the reality space 300.

When the display part 10 does not display the state information 310, the operator 110 needs to take a trouble to remove the VR goggle or the like he/she is wearing, in order to recognize the state of the reality space 300. In the display apparatus 100, the display part 10 displays the state information 310. Thus, the operator 110 can recognize the state of the reality space 300 without removing the display apparatus 100 he/she is wearing.

The display part 10 may further display a virtual input image 420 in the virtual space 400. The virtual input image 420 of the present example is a virtual remote controller.

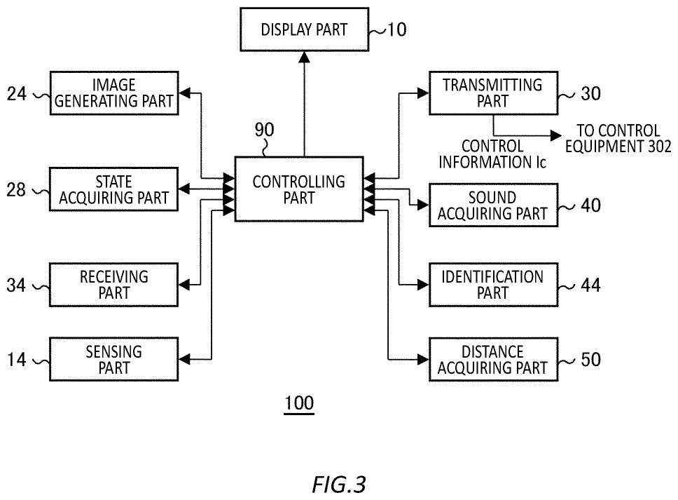

FIG. 3 is a block diagram showing an example of the display apparatus 100 according to one embodiment of the present invention. The display apparatus 100 includes the display part 10 and a transmitting part 30. The display apparatus 100 may include an image generating part 24, a state acquiring part 28, a receiving part 34, a sound acquiring part 40, an identification part 44, a distance acquiring part 50, a sensing part 14, and a controlling part 90.

The display apparatus 100 may be achieved by a computer. The controlling part 90 may be a Central Processing Unit (CPU) of this computer. When the display apparatus 100 is achieved by a computer, a display program which causes this computer to function as the display apparatus 100 may be installed in this computer, or a display program which causes this computer to execute a display method described later may be installed in this computer.

Respective blocks of the display apparatus 100 may be accommodated in a single housing such as a VR goggle, or may be distributed and accommodated in a plurality of housings. When the respective blocks of the display apparatus 100 are accommodated by being distributed to the plurality of housings, the respective blocks may communicate with one another by radio.

The image generating part 24 generates the image of the virtual space 400. The image generating part 24 may generate an image where the image of the virtual space 400 and the state information 310 are superimposed. The display part 10 may display the image where the image of the virtual space 400 and the state information 310 are superimposed.

The transmitting part 30 transmits, to the control equipment 302 (see FIG. 1), control information for controlling the state of the reality space 300 (see FIG. 1). This control information is regarded as control information Ic. When the control equipment 302 is a humidifier, and a humidity H of the reality space 300 (see FIG. 1) is lower than a predetermined humidity Hp, the control information Ic is information for controlling output of this humidifier to become larger.

When the operator 110 (see FIG. 1) is wearing the display apparatus 100, the operator 110 cannot recognize the state of the reality space 300 (see FIG. 1) very well. In the example of FIG. 1, since the operator 110 simulatively experiences a concert, the operator 110 can be easily immersed in this concert. Thus, it is difficult for the operator 110 to recognize the state of the reality space 300 and a change in this state. Therefore, when the state of the reality space 300 is in a state which may affect the life of the operator 110, a risk for the life of the operator 110 may occur.

In the display apparatus 100, the display part 10 displays the state information 310. Thus, even when the operator 110 (see FIG. 1) is wearing the display apparatus 100, the operator 110 can recognize the state of the reality space 300 (see FIG. 1).

In the display apparatus 100, the transmitting part 30 transmits the control information Ic to the control equipment 302 (see FIG. 1). Thus, even when the operator 110 (see FIG. 1) has not recognized the state of the reality space 300 (see FIG. 1), the control equipment 302 (see FIG. 1) can control the state of the reality space 300 (see FIG. 1) to a state unlikely to cause a risk for the life of the operator 110.

The sensing part 14 senses input to the virtual input image 420 (see FIG. 2). The sensing part 14 may sense input to the virtual input image 420 by the operator 110. In the present example, the operator 110 operates the virtual remote controller with feeling as if operating a remote controller in reality. When input to the virtual input image 420 is sensed with the sensing part 14, the transmitting part 30 may transmit the control information Ic to the control equipment 302 (see FIG. 1). In this way, the operator 110 wearing the display apparatus 100 can control the control equipment 302 (see FIG. 1) without removing the display apparatus 100.

The state information 310 (see FIG. 2) may include a state of an atmosphere in the reality space 300 (see FIG. 1). The atmosphere in the reality space 300 may refer to air in the reality space 300. The control information Ic may be information for controlling the state of the atmosphere in the reality space 300.

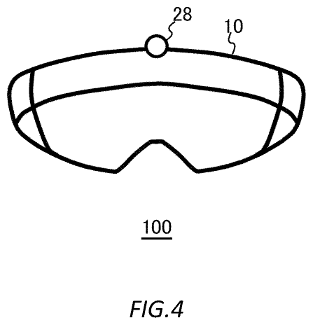

FIG. 4 shows another example of the display apparatus 100. In the present example, the display apparatus 100 includes the state acquiring part 28. The state acquiring part 28 is, for example, a temperature sensor, a humidity sensor, a carbon dioxide sensor, a carbon monoxide sensor, a total volatile organic compound sensor, or a particulate substance sensor. The state acquiring part 28 acquires the state of the reality space 300 (see FIG. 1). When the state acquiring part 28 is the temperature sensor, the state acquiring part 28 acquires a temperature of the reality space 300.

The state acquiring part 28 may acquire at least either of a temperature or a humidity of the reality space 300 (see FIG. 1). The state information 310 may be information representing at least either of a state of the temperature or a state of the humidity of the reality space 300. The control information Ic may be information for controlling at least either of the temperature or the humidity of the reality space 300.

The state acquiring part 28 may acquire at least one of a CO₂ (carbon dioxide) concentration, a concentration of total volatile organic compounds, or a concentration of particulate substances, of the reality space 300 (see FIG. 1). The state information 310 may be information representing a state of the CO₂ (carbon dioxide) concentration of the reality space 300. The control information Ic may be information for controlling at least one of the CO₂ (carbon dioxide) concentration, the concentration of total volatile organic compounds, or the concentration of particulate substances, of the reality space 300.

The controlling part 90 (see FIG. 3) may generate the control information Ic based on the state of the reality space 300 (see FIG. 1) acquired by the state acquiring part 28. The transmitting part 30 (see FIG. 3) may transmit, to the control equipment 302 (see FIG. 1), the control information Ic generated by the controlling part 90.

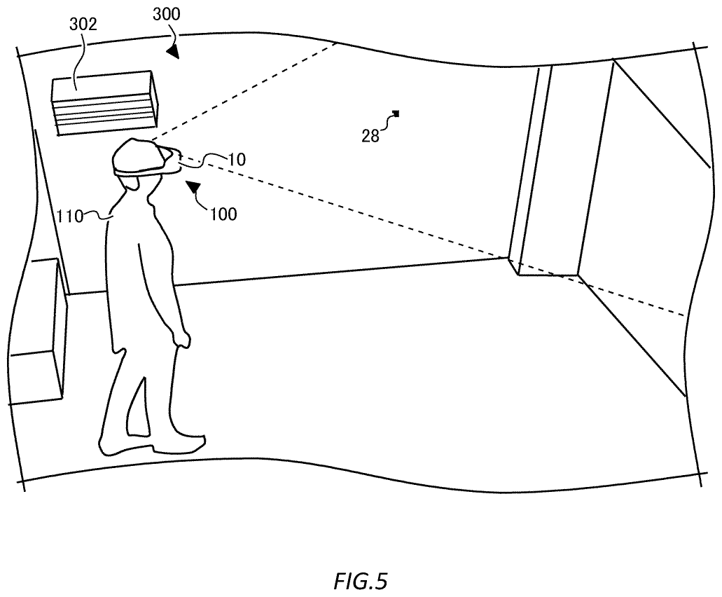

FIG. 5 shows another example of the reality space 300. In the present example, the state acquiring part 28 is arranged in the reality space 300. The receiving part 34 (see FIG. 3) receives the state of the reality space 300 acquired by the state acquiring part 28. The receiving part 34 may receive the state of the reality space 300 by radio. This radio may be short-distance radio such as Wi-fi (registered trademark) or Bluetooth (registered trademark).

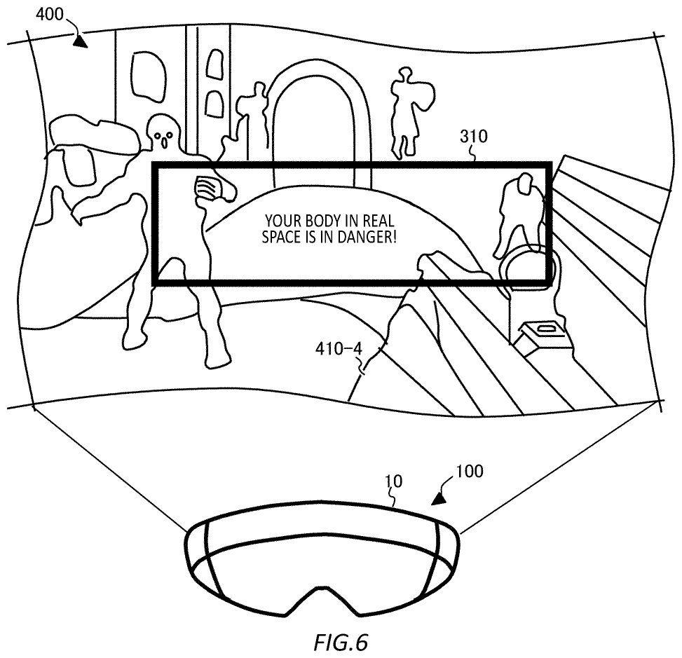

FIG. 6 shows another example of the image of the virtual space 400. In the present example, a virtual object 410-4 is a gun. In the present example, the operator 110 is playing a game while visually recognizing the image of the virtual space 400. In the present example, the operator 110 is operating the virtual object 410-4.

The state acquiring part 28 may acquire a CO (carbon monoxide) concentration of the reality space 300 (see FIG. 1 and FIG. 5). The state information 310 may be information representing a state of the CO (carbon monoxide) concentration of the reality space 300. In the present example, the state information 310 is warning information representing that the state of the reality space 300 is in an abnormal state. In FIG. 6, this warning information is a frame of a thick line, and text-based information describing “Your body in real space is in danger” surrounded by this frame. The state of the reality space 300 being in the abnormal state may refer to a case when the CO (carbon monoxide) concentration of the reality space 300 exceeds a threshold concentration. This threshold concentration is, for example, 200 ppm.

When the CO (carbon monoxide) concentration of the reality space 300 exceeds the threshold concentration, the display part 10 may display, in the virtual space 400, the warning information representing that the state of the reality space 300 is in the abnormal state. When the operator 110 is playing the game while visually recognizing the image of the virtual space 400, the operator 110 can be easily immersed in this game. Thus, even when a fire is occurring in the reality space 300, the operator 110 may not be aware of the fire. In the present example, the display part 10 displays the warning information in the virtual space 400. Thus, even when the operator 110 is immersed in the game, the operator 110 can recognize the state of the reality space 300 (see FIG. 1).

The control equipment 302 (see FIG. 1 and FIG. 5) may be water discharge equipment. The water discharge equipment is, for example, a sprinkler. The control information Ic (see FIG. 3) may be information instructing this water discharge equipment to discharge water. The transmitting part 30 (see FIG. 3) may transmit this control information Ic to this water discharge equipment.

The receiving part 34 (see FIG. 3) may receive information relating to an earthquake or a tsunami. The information relating to the earthquake or the tsunami may be information sent from the Meteorological Agency. The display part 10 may display, in the virtual space 400, warning information that the earthquake has occurred or warning information that the tsunami is approaching. In this way, even when the operator 110 is immersed in the game, the operator 110 can recognize occurrence of the earthquake or the tsunami.

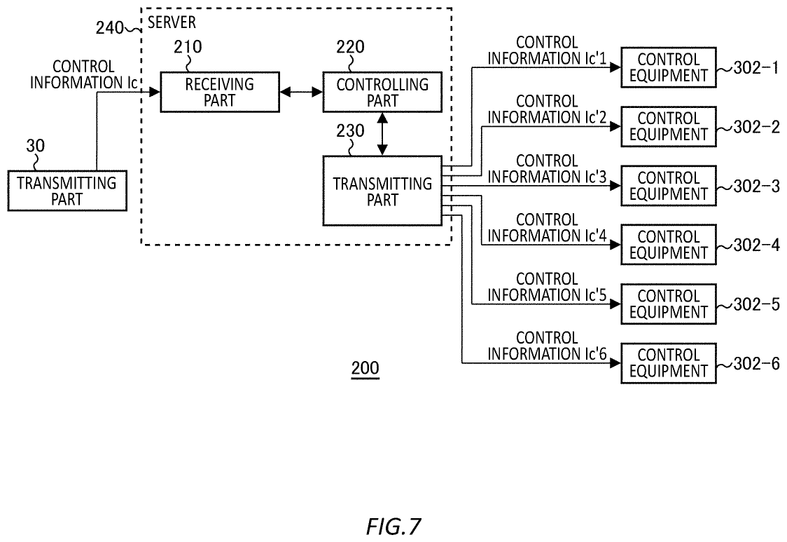

FIG. 7 shows an example of a control system 200. The control system 200 has the transmitting part 30, a server 240, and a plurality of pieces of the control equipment 302. In the present example, the control system 200 has six pieces of the control equipment 302 (control equipment 302-1 to control equipment 302-6). The control system 200 is, for example, a Home Energy Management System (HEMS). The plurality of pieces of control equipment 302 may be arranged in the reality space 300.

The server 240 may have a receiving part 210, a controlling part 220, and a transmitting part 230. The receiving part 210 receives the control information Ic transmitted by the transmitting part 30. The controlling part 220 is, for example, a CPU. The transmitting part 230 transmits control information to the control equipment 302. This control information is regarded as control information Ic′.

The control equipment 302-1 is, for example, air-conditioning equipment (an air conditioner). The control equipment 302-2 is, for example, an air cleaner. The control equipment 302-3 is, for example, a humidifier. The control equipment 302-4 is, for example, a dehumidifier. The control equipment 302-5 is, for example, a ventilating fan. The control equipment 302-6 is, for example, a sprinkler.

The controlling part 220 may generate the control information Ic′ based on the control information Ic. The controlling part 220 may generate, based on the control information Ic, the control information Ic′ for causing the state of the reality space 300 to become a predetermined state. This control information Ic′ is, for example, control information of each piece of control equipment 302 which can reduce a risk for the life of the operator 110.

The transmitting part 230 may transmit the control information Ic′ to the plurality of pieces of control equipment 302. In the present example, the transmitting part 230 transmits control information Ic′1 to control information Ic′6 to the control equipment 302-1 to the control equipment 302-6, respectively. In the present example, the transmitting part 30 of the display apparatus 100 (see FIG. 3) indirectly transmits the control information Ic′ to the plurality of pieces of control equipment 302.

The state information 310 (see FIG. 2 and FIG. 6) may be control information of the control system 200. In the present example, the state information 310 is the control information Ic′1 to the control information Ic′6 of the HEMS. The control information Ic may also be setting information of the control equipment 302. The setting information of the control equipment 302 is information for causing the control equipment 302 to perform predetermined control at startup of the control equipment 302, or the like. When the control equipment 302 is air-conditioning equipment (an air conditioner), the setting information of this control equipment 302 is, for example, a target set temperature at startup of this air-conditioning equipment, or the like.

The display part 10 may display the setting information of the control equipment 302. In this way, the operator 110 (see FIG. 1 and FIG. 5) can recognize the setting information of the control equipment 302 in the virtual space 400.

The controlling part 90 (see FIG. 3) of the display apparatus 100 may generate the control information Ic′ based on the state of the reality space 300 (see FIG. 1) acquired by the state acquiring part 28 (see FIG. 3). The transmitting part 30 of the display apparatus 100 may directly transmit this control information Ic′ to the plurality of pieces of control equipment 302. The transmitting part 30 transmitting the control information Ic to the control equipment 302 may include the case when the transmitting part 30 indirectly transmits the control information Ic′ to the plurality of pieces of control equipment 302 (the case of FIG. 7), and the case when that transmission is performed directly.

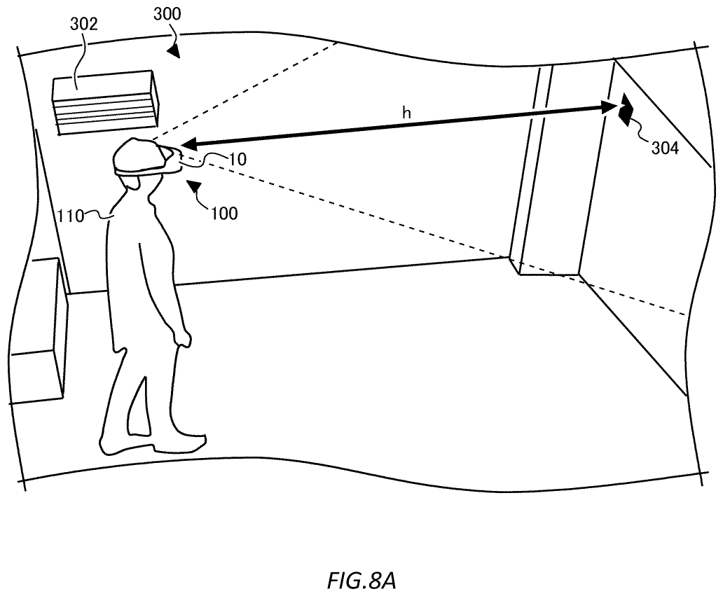

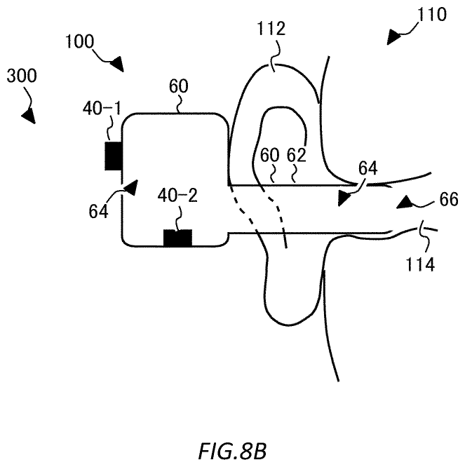

FIG. 8A shows another example of the reality space 300. A sound generation source 304 is arranged in the reality space 300. The sound generation source 304 is, for example, a speaker, an intercom, or the like.

The sound acquiring part 40 (see FIG. 3) acquires a sound in the reality space 300. The sound in the reality space 300 may include a sound occurring inside the reality space 300, and a sound occurring outside of the reality space 300 which is propagated to the inside. The sound occurring inside the reality space 300 may be a sound generated by the sound generation source 304.

The identification part 44 (see FIG. 3) identifies whether the sound acquired by the sound acquiring part 40 (see FIG. 3) is the sound in the reality space 300 or the sound in the virtual space 400 (see FIG. 2 and FIG. 6). If the sound acquired by the sound acquiring part 40 is identified as the sound in the reality space 300 by the identification part 44, the display part 10 may display, in the virtual space 400, information that the sound is being generated in the reality space 300.

When the operator 110 is wearing the display apparatus 100, the operator 110 may listen to the sound occurring in the virtual space 400 (see FIG. 2 and FIG. 6). In the example of FIG. 2, the operator 110 may listen to a sound of a concert because the operator is simulatively experiencing the concert. In the example of FIG. 6, the operator 110 may listen to a sound generated in a game because the operator is playing the game. These sounds may be in big volume. Thus, it may be difficult for the operator 110 to identify the sound in the reality space 300 from the sound in the virtual space 400. When the operator 110 is immersed in the virtual space 400, the operator 110 may not recognize the sound in the reality space 300.

In the present example, the identification part 44 (see FIG. 3) identifies the sound in the reality space 300 from the sound in the virtual space 400 (see FIG. 2 and FIG. 6). If the sound acquired by the sound acquiring part 40 (see FIG. 3) is identified as the sound in the reality space 300, in the present example, the display part 10 displays, in the virtual space 400, information that the sound is being generated in the reality space 300. Thus, even when the operator 110 is wearing the display apparatus 100, the operator 110 can recognize that the sound is being generated in the reality space 300.

The sound in the reality space 300 may be, for example, a warning sound informing occurrence of a state such as an abnormality in the CO (carbon monoxide) concentration of the reality space 300. In this way, even when a fire or the like is occurring in the reality space 300, the operator 110 can avoid the risk of his/her life.

The distance acquiring part 50 (see FIG. 3) acquires a distance h between the sound generation source 304 and the display part 10. A threshold distance of the distance h is regarded as a threshold distance ht. The threshold distance ht may be a distance which allows the identification part 44 (see FIG. 3) to identify whether the sound in the reality space 300 is a voice of the operator 110. When the operator 110 is immersed in the virtual space 400, the operator 110 may utter a voice along with immersion in the virtual space 400. This voice is a singing voice or the like of the operator 110 with the music of the concert in the example of FIG. 2, and is a voice of motivation or the like along with immersion in the game in the example of FIG. 6.

When the distance h exceeds the threshold distance ht, the display part 10 may display, in the virtual space 400 (see FIG. 2 and FIG. 6), information that the sound is being generated in the reality space 300. It may be difficult for the identification part 44 (see FIG. 3) to identify whether the sound in the reality space 300 is the sound of the sound generation source 304 or the voice of the operator 110. When the distance h exceeds the threshold distance ht, the identification part 44 may identify that the sound in the reality space 300 is the sound of the sound generation source 304. When the distance h is the threshold distance ht or shorter, the identification part 44 may identify that the sound in the reality space 300 is the voice of the operator 110.

When the operator 110 is wearing the display apparatus 100, the threshold distance ht may be a distance between the mouth of the operator 110 and the sound acquiring part 40 (see FIG. 3). The threshold distance ht is, for example, 30 cm.

FIG. 8B is a schematic view illustrating a vicinity of an ear 112 of the operator 110. In the present example, the operator 110 is wearing the display apparatus 100. The display apparatus 100 may include a plurality of the sound acquiring parts 40. In the present example, the display apparatus 100 includes two sound acquiring parts 40 (a sound acquiring part 40-1 and a sound acquiring part 40-2).

In the present example, the display apparatus 100 has a housing 60. The housing 60 includes an insertion portion 62. The insertion portion 62 is inserted into an ear canal 114 of the operator 110. The sound acquiring part 40-1 is provided outside the housing 60. The outside of the housing 60 may refer to the reality space 300. An internal space 64 of the housing 60 is provided with the sound acquiring part 40-2. The internal space 64 is in communication with the ear canal 114 through an opening 66 provided for the housing 60. The internal space 64 is isolated from the reality space 300 except for the opening 66.

The sound acquiring part 40-1 acquires a sound in the reality space 300. The sound acquiring part 40-2 acquires a sound inside the operator 110. In the present example, the sound acquiring part 40-2 acquires a sound in the ear canal 114. When the operator 110 utters a voice, a vibration associated with the voice uttered by the operator 110 may be propagated from a vocal band to the ear canal 114 of the operator 110. In the present example, the sound acquiring part 40-2 acquires this vibration propagated to the ear canal 114. Since the internal space 64 is isolated from the reality space 300, it is difficult for the sound acquiring part 40-2 to acquire the sound of the reality space 300. Thus, the sound acquiring part 40-2 can easily acquire the sound generated by the operator 110.

The sound acquired by the sound acquiring part 40-1 is regarded as a sound Vo, and the sound acquired by the sound acquiring part 40-2 is regarded as a sound Vi. The identification part 44 may identify the sound Vo from the sound Vi. The identification part 44 may compare intensity of the sound Vo with intensity of the sound Vi. The intensity of the sound may refer to a vibration amplitude of a sound wave according to this sound. When the intensity of the sound Vo is greater than the intensity of the sound Vi, the identification part 44 may identify that the sound acquired by the sound acquiring part 40 is the sound of the sound generation source 304. When the intensity of the sound Vi is greater than the intensity of the sound Vo, the identification part 44 may identify that the sound acquired by the sound acquiring part 40 is the sound due to the voice uttered by the operator 110.

The identification part 44 may acquire a time at which the sound Vo is recognized. This time is regarded as a time to. The identification part 44 may acquire a time at which the sound Vi is recognized. This time is regarded as a time ti. The identification part 44 may acquire a time difference between the time to and the time ti. When the time to is before the time ti, the identification part 44 may identify that the sound acquired by the sound acquiring part 40 is the sound of the sound generation source 304. When the time ti is before the time to, the identification part 44 may identify that the sound acquired by the sound acquiring part 40 is the sound due to the voice uttered by the operator 110.

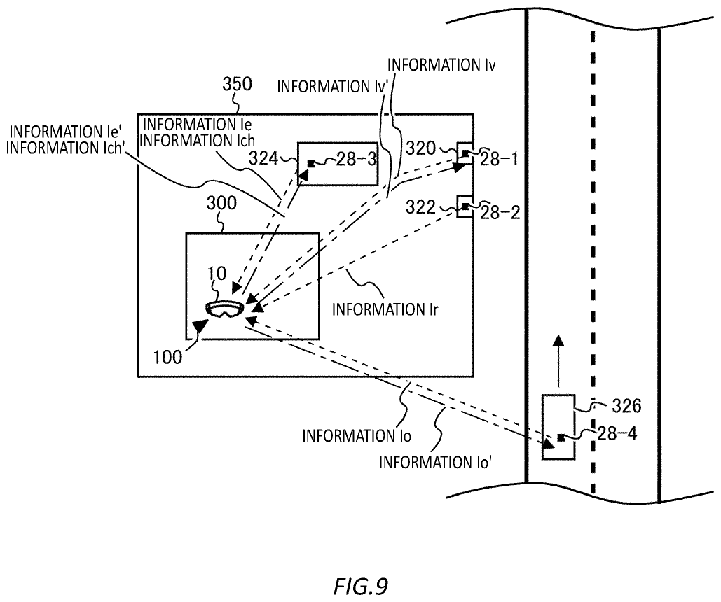

FIG. 9 shows examples of the reality space 300 and surroundings of the reality space 300. In the present example, the reality space 300 is a part of a building 350. The building 350 is, for example, a house. In the present example, a recognizing part 320, an accepting part 322, and electrical equipment 324 are arranged in the building 350. In the present example, it is assumed that a supplier 326 who supplies a supply item to the operator 110 is moving on a road in front of the building 350. The control equipment 302 may include the recognizing part 320, the accepting part 322, the electrical equipment 324, and the supplier 326.

The state acquiring part 28 may further acquire information on the outside of the reality space 300. The recognizing part 320, the accepting part 322, and the electrical equipment 324 may be provided with the state acquiring part 28. The supplier 326 may have the state acquiring part 28. The state acquiring parts 28 provided for the recognizing part 320, the accepting part 322, and the electrical equipment 324 are regarded as a state acquiring part 28-1 to a state acquiring part 28-3, respectively. The state acquiring part 28 possessed by the supplier 326 is regarded as a state acquiring part 28-4. In the present example, the state acquiring part 28-1 to the state acquiring part 28-4 acquire the information on the outside of the reality space 300.

The state information 310 (see FIG. 2 and FIG. 6) may include at least one of information representing a visitor to the reality space 300, information representing a state of an accepting part which accepts a delivery item for the reality space 300, or order information for a supplier who supplies a supply item to the operator 110. The information representing the visitor to the reality space 300 is regarded as information Iv. The information representing the state of the accepting part which accepts the delivery item for the reality space 300 is regarded as information Ir. The order information for the supplier who supplies the supply item to the operator 110 is regarded as order information Io. The information Iv, the information Ir, and the order information Io are examples of the information on the state outside of the reality space 300 which relates to the state of the reality space 300.

The visitor to the reality space 300 may refer to a visitor to the building 350. The recognizing part 320 may recognize the visitor to the building 350. The recognizing part 320 is, for example, an intercom. The state acquiring part 28-1 may acquire a state of the recognizing part 320. In the present example, the state acquiring part 28-1 acquires a state where the visitor pushes the intercom.

The recognizing part 320 may transmit, to the display apparatus 100, the state of the recognizing part 320 acquired by the state acquiring part 28-1. In the present example, the recognizing part 320 enables the operator 110 to recognize the state of the reality space 300 by transmitting the state of the recognizing part 320 to the display apparatus 100. When input to the virtual input image 420 is sensed with the sensing part 14 (see FIG. 3), the transmitting part 30 (see FIG. 3) may transmit the control information Ic relating to control on the recognizing part 320 to the recognizing part 320. The recognizing part 320 may control the state of the reality space 300 based on this control information Ic.

The receiving part 34 (see FIG. 3) of display apparatus 100 may receive the state of the recognizing part 320. The controlling part 90 (see FIG. 3) of the display apparatus 100 may generate the information Iv based on the state of the recognizing part 320. The display part 10 may display the information Iv in the virtual space 400. In this way, the operator 110 can recognize the visitor to the reality space 300 even when the operator 110 is immersed in the virtual space 400. The operator 110 can recognize the visitor to the reality space 300 without removing the display apparatus 100 he/she is wearing.

The recognizing part 320 may recognize a state of a key to the building 350. The state acquiring part 28-1 may acquire the state of the key to the building 350. The state of the key to the building 350 may be a state on whether the main entrance of the building 350 has been locked or not. In the present example, the recognizing part 320 enables the operator 110 to recognize the state of the reality space 300 by transmitting the state of the key to the building 350 to the display apparatus 100. When input to the virtual input image 420 is sensed with the sensing part 14 (see FIG. 3), the transmitting part 30 (see FIG. 3) may transmit, to the recognizing part 320, the control information Ic relating to control on the state of the key to the building 350. The recognizing part 320 may control the state of the reality space 300 based on this control information Ic.

The receiving part 34 (see FIG. 3) of the display apparatus 100 may receive the state of the key to the building 350. The controlling part 90 (see FIG. 3) of the display apparatus 100 may generate information relating to the lock on the main entrance of the building 350 based on the state of the key to the building 350. The display part 10 may display this information relating to the lock in the virtual space 400.

The delivery item for the reality space 300 may refer to a delivery item for the building 350. This delivery item is, for example, a package such as TA-Q-BIN (registered trademark). The accepting part 322 which accepts this delivery item is, for example, a home delivery box. The state acquiring part 28-2 may acquire a state of the accepting part 322. The state of the accepting part 322 is, for example, a state such as the delivery item not being delivered yet, just delivered, or already delivered, to the accepting part 322.

The accepting part 322 may transmit, to the display apparatus 100, the state of the accepting part 322 acquired by the state acquiring part 28-2. In the present example, the accepting part 322 enables the operator 110 to recognize the state of the reality space 300 by transmitting the state of the accepting part 322 to the display apparatus 100. When input to the virtual input image 420 is sensed with the sensing part 14 (see FIG. 3), the transmitting part 30 (see FIG. 3) may transmit the control information Ic relating to control on the accepting part 322 to the accepting part 322. The accepting part 322 may control the state of the reality space 300 based on this control information Ic.

The receiving part 34 (see FIG. 3) of the display apparatus 100 may receive the state of the accepting part 322. The controlling part 90 (see FIG. 3) of the display apparatus 100 may generate the information Ir based on the state of the accepting part 322. The display part 10 may display the information Ir in the virtual space 400. In this way, the operator 110 can recognize the information Ir even when the operator 110 is immersed in the virtual space 400. The operator 110 can recognize the information Ir without removing the display apparatus 100 he/she is wearing.

When the accepting part 322 is a home delivery box, the control information Ic relating to the control on the accepting part 322 may include a password or the like for locking and unlocking the home delivery box. In this way, the operator 110 wearing the display apparatus 100 can lock and unlock the home delivery box without removing the display apparatus 100.

The supplier 326 is, for example, a home delivery service provider. The state acquiring part 28-4 may acquire a supply state of this supply item. The supply state of this supply item is, for example, a status state of an order to this supplier. This status state is a state such as the supply item not being shipped yet, already shipped but not arrived yet (in delivery), or already arrived.

The supplier 326 may transmit, to the display apparatus 100, the supply state of the supply item acquired by the state acquiring part 28-4. In the present example, the supplier 326 enables the operator 110 to recognize the state of the reality space 300 by transmitting the state of the supplier 326 to the display apparatus 100. When input to the virtual input image 420 is sensed with the sensing part 14 (see FIG. 3), the transmitting part 30 (see FIG. 3) may transmit the control information Ic relating to control on the supplier 326 to the supplier 326. The supplier 326 may control the state of the reality space 300 based on this control information Ic.

The receiving part 34 (see FIG. 3) of the display apparatus 100 may receive the supply state of this supply item. The controlling part 90 (see FIG. 3) of the display apparatus 100 may generate the order information Io based on the supply state of this supply item.

The display part 10 may display the order information Io in the virtual space 400. In this way, the operator 110 can recognize the order information Io even when the operator 110 is immersed in the virtual space 400. The operator 110 can recognize the order information Io without removing the display apparatus 100 he/she is wearing.

The state information 310 (see FIG. 2 and FIG. 6) may include information representing a state of the electrical equipment 324. This information is regarded as information Ie. The electrical equipment 324 is, for example, an electric vehicle. The electrical equipment 324 may be a smartphone, a notebook PC, or the like. When the electrical equipment 324 is an electric vehicle, the information Ie may be information representing a state of charge of the electrical equipment 324. The electrical equipment 324 may be arranged outside the reality space 300.

The state acquiring part 28-3 may acquire the state of charge of the electrical equipment 324. The state of charge of the electrical equipment 324 may refer to a percentage of a current amount of charge with respect to the full amount of charge (that is, a charging rate). The electrical equipment 324 may transmit, to the display apparatus 100, the state of charge of the electrical equipment 324 acquired by the state acquiring part 28-3. In the present example, the electrical equipment 324 enables the operator 110 to recognize the state of the reality space 300 by transmitting the state of the electrical equipment 324 to the display apparatus 100. When input to the virtual input image 420 is sensed with the sensing part 14 (see FIG. 3), the transmitting part 30 (see FIG. 3) may transmit the control information Ic relating to control on the electrical equipment 324 to the electrical equipment 324. The electrical equipment 324 may control the state of the reality space 300 based on this control information Ic.

The receiving part 34 (see FIG. 3) of the display apparatus 100 may receive the state of charge of the electrical equipment 324. The controlling part 90 (see FIG. 3) of the display apparatus 100 may generate information representing the state of charge based on the state of charge of the electrical equipment 324. This information is regarded as information Ich. The information Ich may be information on the charging rate, information notifying that the full charge has been reached, or the like.

The display part 10 may display the information Ich in the virtual space 400. In this way, the operator 110 can recognize the state of charge of the electrical equipment 324 even when the operator 110 is immersed in the virtual space 400. The operator 110 can recognize the state of charge of the electrical equipment 324 without removing the display apparatus 100 he/she is wearing.

The electrical equipment 324 may be a bath boiler. The information Ie may be information representing a state of the bath boiler. This information Ie may be information such as reheating being performed or reheating being completed. When the electrical equipment 324 is a bath boiler, the display part 10 may display the information Ie representing the state of the bath boiler in the virtual space 400. In this way, the operator 110 can recognize the state of the bath boiler even when the operator 110 is immersed in the virtual space 400. The operator 110 can recognize the state of the bath boiler without removing the display apparatus 100 he/she is wearing.

Information on whether to lock the building 350 or release the lock on the building 350 may be displayed in the virtual input image 420 (see FIG. 2). This information is regarded as information Iv′. The operator 110 (see FIG. 1) may input, to the virtual input image 420, whether to lock the building 350 or release the lock on the building 350. Input to the virtual input image 420 may refer to the operator 110 pushing a button displayed in the virtual input image 420 with a finger of the operator 110.

The sensing part 14 (see FIG. 3) senses input to the virtual input image 420 (see FIG. 2). The control information Ic (see FIG. 3) may include the information Iv′. When the input to the virtual input image 420 is sensed with the sensing part 14, the transmitting part 30 (see FIG. 3) may transmit the information Iv′ to the recognizing part 320. In this way, the operator 110 wearing the display apparatus 100 can lock the building 350 or release the lock on the building 350 without removing the display apparatus 100.

The order information for the supplier 326 may be displayed in the virtual input image 420 (see FIG. 2). This information is regarded as information Io′. The information Io′ is, for example, information on food ordered to the home delivery service provider. The operator 110 (see FIG. 1) may input an order for the supplier 326 to the virtual input image 420.

The sensing part 14 (see FIG. 3) senses the input to the virtual input image 420 (see FIG. 2). The control information Ic (see FIG. 3) may include the information Io′. When the input to the virtual input image 420 is sensed with the sensing part 14, the transmitting part 30 (see FIG. 3) may transmit the information Io′ to the supplier 326. The transmitting part 30 (see FIG. 3) may also transmit the information Io′ to a store of the supplier 326. In this way, the operator 110 wearing the display apparatus 100 can make an order to the supplier 326 without removing the display apparatus 100.

Control information of the electrical equipment 324 may be displayed in the virtual input image 420 (see FIG. 2). This control information when the electrical equipment 324 is an electric vehicle is regarded as information Ich′. The information Ich′ is, for example, information that charging of the electric vehicle has started or ended. This control information when the electrical equipment 324 is a bath boiler is regarded as information Ie′. The information Ie′ is, for example, information that reheating of the bath boiler has started or ended.

The operator 110 (see FIG. 1) may input an operation on the electrical equipment 324 in the virtual input image 420. The sensing part 14 (see FIG. 3) senses the input to the virtual input image 420 (see FIG. 2). The control information Ic (see FIG. 3) may include the information Ich′ or the information Ie′. When the input to the virtual input image 420 is sensed with the sensing part 14, the transmitting part 30 (see FIG. 3) may transmit the information Ich′ or the information Ie′ to the electrical equipment 324. In this way, the operator 110 wearing the display apparatus 100 can perform an operation on the electrical equipment 324 without removing the display apparatus 100.

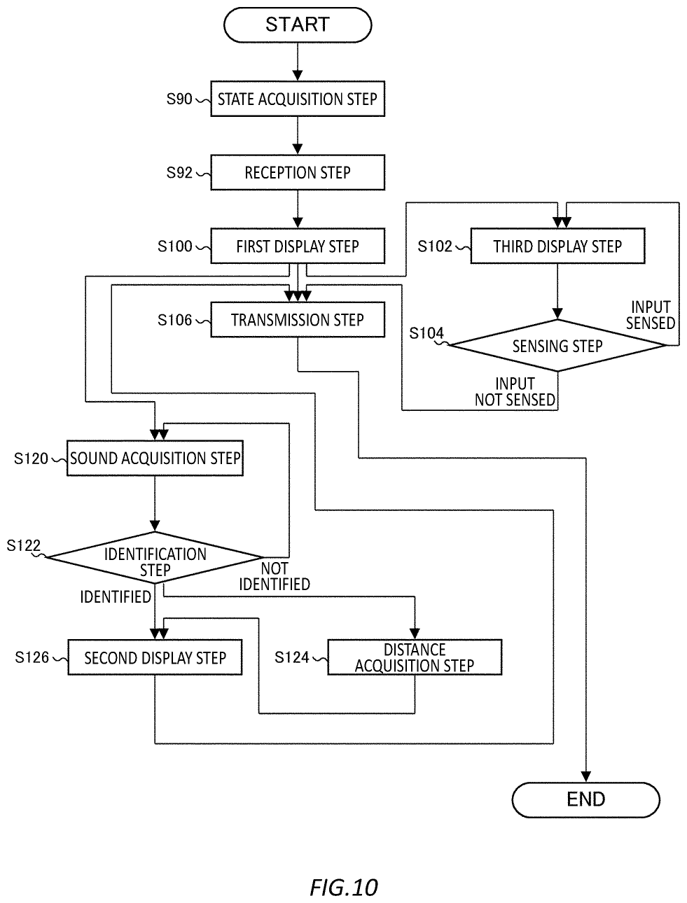

FIG. 10 is a flowchart including an example of a display method according to one embodiment of the present invention. The display method according to one embodiment of the present invention is an example of a display method in the display apparatus 100 (see FIG. 3). The display method includes a first display step S100 and a transmission step S106. The display method may include a state acquisition step S90, a reception step S92, a third display step S102, a sensing step S104, a sound acquisition step S120, an identification step S122, a distance acquisition step S124, and a second display step S126.

The first display step S100 is a step in which the display part 10 displays an image of the virtual space 400, and the state information 310 relating to a state of the reality space 300 where the operator 110 of the display part 10 is present. After the first display step, the display method proceeds to the transmission step S106, the third display step S102, or the sound acquisition step S120.

The transmission step S106 is a step in which the transmitting part 30 transmits, to the control equipment 302 which is arranged in the reality space 300 and controls the state of the reality space 300, the control information Ic for controlling the state of the reality space 300. In this way, even when the operator 110 (see FIG. 1) has not recognized the state of the reality space 300 (see FIG. 1), the control equipment 302 (see FIG. 1) can control the state of the reality space 300 (see FIG. 1) to a state unlikely to cause a risk for the life of the operator 110.

The third display step S102 is a step in which the display part 10 further displays the virtual input image 420 in the virtual space 400. The sensing step S104 is a step in which the sensing part 14 senses input to the virtual input image 420. When input to the virtual input image 420 is sensed in the sensing step S104, the display method proceeds to the transmission step S106. When input to the virtual input image 420 is not sensed in the sensing step S104, the display method returns to the third display step S102.

The transmission step S106 may be a step in which, when input to the virtual input image 420 is sensed in the sensing step S104, the transmitting part 30 transmits the control information Ic to the control equipment 302 (see FIG. 1). In this way, the operator 110 (see FIG. 1) wearing the display apparatus 100 (see FIG. 1) can control the control equipment 302 without removing the display apparatus 100.

The state acquisition step S90 is a step in which the state acquiring part 28 acquires the state of the reality space 300. The reception step S92 is a step in which the receiving part 34 receives the state of the reality space 300 acquired in the state acquisition step S90. The first display step S100 may be a step in which the display part 10 displays the state of the reality space 300 received in the reception step S92.

The sound acquisition step S120 is a step in which the sound acquiring part 40 acquires a sound in the reality space 300. The identification step S122 is a step in which the identification part 44 identifies whether the sound acquired in the sound acquisition step S120 is a sound in the virtual space 400 or a sound in the reality space 300. If the sound acquired in the sound acquisition step S120 is identified as a sound in the reality space 300 in the identification step S122, the display method proceeds to the second display step S126 or the distance acquisition step S124. When this sound is not identified as a sound in the reality space 300 in the identification step S122, the display method returns to the sound acquisition step S120.

The second display step S126 is a step in which, if the sound acquired in the sound acquisition step S120 is identified as a sound in the reality space 300 in the identification step S122, the display part 10 displays, in the virtual space 400, information that this sound is being generated. The distance acquisition step S124 is a step in which the distance acquiring part 50 acquires a distance between the sound generation source 304 of the sound acquired in the sound acquisition step S120 and the display part 10. When the distance acquired in the distance acquisition step S124 exceeds a threshold distance, in the second display step S126, the display part 10 may display, in the virtual space 400, information that the sound acquired in the sound acquisition step S120 is being generated. After the second display step S126, the display method proceeds to the transmission step S106.

The state information 310 may include at least one of the information Iv representing a visitor to the reality space 300, the information Ir representing a state of the accepting part 322 which accepts a delivery item for the reality space 300, or the order information Io for the supplier 326 who supplies a supply item to the operator 110.

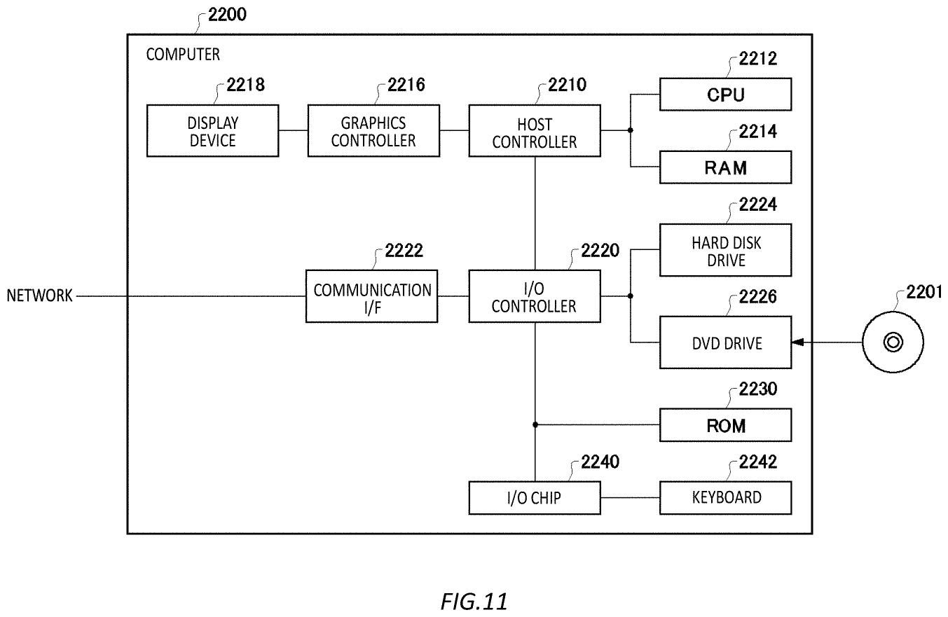

FIG. 11 shows an example of a computer 2200 in which the display apparatus 100 according to one embodiment of the present invention may be entirely or partially embodied. A program installed in the computer 2200 can cause the computer 2200 to function as an operation associated with the display apparatus 100 according to an embodiment of the present invention or one or more sections of the display apparatus 100, or to execute the operation or the one or more sections, or can cause the computer 2200 to execute each step (see FIG. 10) according to the display method of the present invention. This program may be executed by a CPU 2212 to cause the computer 2200 to execute a particular operation associated with some or all of the blocks in the flowchart (FIG. 10) and the block diagrams (FIG. 3 and FIG. 7) described in the present specification.

The computer 2200 according to one embodiment of the present invention includes the CPU 2212, a RAM 2214, a graphics controller 2216, and a display device 2218. The CPU 2212, the RAM 2214, the graphics controller 2216, and the display device 2218 are mutually connected by a host controller 2210. The computer 2200 further includes input and output units such as a communication interface 2222, a hard disk drive 2224, a DVD-ROM drive 2226, and an IC card drive. The communication interface 2222, the hard disk drive 2224, the DVD-ROM drive 2226, and the IC card drive, and the like are connected to the host controller 2210 via an input and output controller 2220. The computer further includes legacy input and output units such as a ROM 2230 and a keyboard 2242. The ROM 2230, the keyboard 2242, and the like are connected to the input and output controller 2220 through an input and output chip 2240.

The CPU 2212 operates according to programs stored in the ROM 2230 and the RAM 2214, thereby controlling each unit. The graphics controller 2216 obtains image data generated by the CPU 2212 on a frame buffer or the like provided in the RAM 2214 or in the RAM 2214 itself to cause the image data to be displayed on the display device 2218.

The communication interface 2222 communicates with other electronic devices via a network. The hard disk drive 2224 stores programs and data used by the CPU 2212 in the computer 2200. The DVD-ROM drive 2226 reads the programs or the data from the DVD-ROM 2201, and provides the read programs or data to the hard disk drive 2224 via the RAM 2214. The IC card drive reads programs and data from an IC card, or writes programs and data to the IC card.

The ROM 2230 stores a boot program or the like executed by the computer 2200 at the time of activation, or a program depending on the hardware of the computer 2200. The input and output chip 2240 may connect various input and output units via a parallel port, a serial port, a keyboard port, a mouse port, or the like to the input and output controller 2220.

The program is provided by a computer readable medium such as the DVD-ROM 2201 or the IC card. The program is read from a computer readable medium, installed in the hard disk drive 2224, the RAM 2214, or the ROM 2230 which are also examples of the computer readable medium, and executed by the CPU 2212. The information processing described in these programs is read by the computer 2200 and provides cooperation between the programs and various types of hardware resources. An apparatus or method may be constituted by realizing the operation or processing of information in accordance with the usage of the computer 2200.

For example, when a communication is performed between the computer 2200 and an external device, the CPU 2212 may execute a communication program loaded onto the RAM 2214 to instruct communication processing to the communication interface 2222, on the basis of the processing described in the communication program. The communication interface 2222, under control of the CPU 2212, reads transmission data stored on a transmission buffering region provided in a recording medium such as the RAM 2214, the hard disk drive 2224, the DVD-ROM 2201, or the IC card, and transmits the read transmission data to a network or writes reception data received from a network to a reception buffering region or the like provided on the recording medium.

The CPU 2212 may cause all or a necessary portion of a file or a database to be read into the RAM 2214, the file or the database having been stored in an external recording medium such as the hard disk drive 2224, the DVD-ROM drive 2226 (DVD-ROM 2201), the IC card, or the like. The CPU 2212 may perform various types of processing on the data on the RAM 2214. The CPU 2212 may then write back the processed data to the external recording medium.

Various types of information, such as various types of programs, data, tables, and databases, may be stored in the recording medium to undergo information processing. The CPU 2212 may perform various types of processing on the data read from the RAM 2214, which includes various types of operations, information processing, condition judging, conditional branch, unconditional branch, search or replace of information, or the like, as described throughout the present disclosure and designated by an instruction sequence of programs. The CPU 2212 may write the result back to the RAM 2214.

The CPU 2212 may search for information in a file, a database, or the like in the recording medium. For example, when a plurality of entries, each having an attribute value of a first attribute associated with an attribute value of a second attribute, are stored in the recording medium, the CPU 2212 may search for an entry matching the condition whose attribute value of the first attribute is designated, from among the plurality of entries, read the attribute value of the second attribute stored in the entry, and read a second attribute value to obtain the attribute value of the second attribute associated with the first attribute satisfying the predetermined condition.

The above-explained program or software modules may be stored in the computer readable media on the computer 2200 or of the computer 2200. A recording medium such as a hard disk or a RAM provided in a server system connected to a dedicated communication network or the Internet can be used as the computer readable media. The program may be provided to the computer 2200 by the recording medium.

While the present invention has been described by way of the embodiments, the technical scope of the present invention is not limited to the above-described embodiments. It is apparent to persons skilled in the art that various alterations or improvements can be made to the above-described embodiments. It is apparent from the description of the claims that embodiments added with such alterations or improvements can also be included in the technical scope of the present invention.

It should be noted that the operations, procedures, steps, stages, and the like of each process performed by an apparatus, system, program, and method shown in the claims, embodiments, or diagrams can be realized in any order as long as the order is not indicated by “prior to,” “before,” or the like and as long as the output from a previous process is not used in a later process. Even if the operation flow is described using phrases such as “first” or “next” in the claims, embodiments, or diagrams for convenience, it does not necessarily mean that the process must be performed in this order.

### EXPLANATION OF REFERENCES

10 . . . display part, 14 . . . sensing part, 24 . . . image generating part, 28 . . . state acquiring part, 30 . . . transmitting part, 34 . . . receiving part, 40 . . . sound acquiring part, 44 . . . identification part, 50 . . . distance acquiring part, 60 . . . housing, 62 . . . insertion portion, 64 . . . internal space, 66 . . . opening, 90 . . . controlling part, 100 . . . display apparatus, 110 . . . operator, 112 . . . ear, 114 . . . ear canal, 200 . . . control system, 210 . . . receiving part, 220 . . . controlling part, 230 . . . transmitting part, 240 . . . server, 300 reality space, 302 . . . control equipment, 304 . . . sound generation source, 310 . . . state information, 320 . . . recognizing part, 322 . . . accepting part, 324 . . . electrical equipment, 326 . . . supplier, 350 . . . building, 400 . . . virtual space, 410 . . . virtual object, 420 . . . virtual input image, 2200 . . . computer, 2201 . . . DVD-ROM, 2210 . . . host controller, 2212 . . . CPU, 2214 . . . RAM, 2216 . . . graphics controller, 2218 . . . display device, 2220 . . . input and output controller, 2222 . . . communication interface, 2224 . . . hard disk drive, 2226 . . . DVD-ROM drive, 2230 . . . ROM, 2240 . . . input and output chip, 2242 . . . keyboard.

What is claimed is:

1. A display apparatus, comprising:
a display part which displays an image of a virtual space;
a transmitting part; and
a sound acquiring part, wherein
the display part further displays state information relating to a state of a reality space where an operator of the display part is present,
the display apparatus further comprises an identification part which identifies whether a sound acquired by the sound acquiring part is a sound in the virtual space or a sound in the reality space,
if the sound acquired by the sound acquiring part is identified as the sound in the reality space by the identification part, the display part displays, in the virtual space, information that the sound is being generated, and
the transmitting part transmits, to control equipment which controls the state of the reality space, control information for controlling the state of the reality space.

2. The display apparatus according to claim 1,
further comprising a sensing part, wherein
the display part further displays a virtual input image in the virtual space, and
when input to the virtual input image is sensed with the sensing part, the transmitting part transmits the control information to the control equipment.

3. The display apparatus according to claim 2, wherein the state information includes a state of an atmosphere in the reality space.

4. The display apparatus according to claim 3, further comprising a state acquiring part which acquires the state of the reality space.

5. The display apparatus according to claim 3,
further comprising a receiving part, wherein
the state of the reality space is acquired by a state acquiring part, and
the receiving part receives the state of the reality space acquired by the state acquiring part.

6. The display apparatus according to claim 4, wherein
the state acquiring part acquires at least either of a temperature or a humidity of the reality space, and
the control information is information for controlling the at least either of the temperature or the humidity of the reality space.

7. The display apparatus according to claim 5, wherein
the state acquiring part acquires at least either of a temperature or a humidity of the reality space, and
the control information is information for controlling the at least either of the temperature or the humidity of the reality space.

8. The display apparatus according to claim 4, wherein
the state acquiring part acquires at least one of a concentration of carbon dioxide, a concentration of total volatile organic compounds, or a concentration of particulate substances, of the reality space, and
the control information is information for controlling at least one of the concentration of carbon dioxide, the concentration of total volatile organic compounds, or the concentration of particulate substances, of the reality space.

9. The display apparatus according to claim 5, wherein
the state acquiring part acquires at least one of a concentration of carbon dioxide, a concentration of total volatile organic compounds, or a concentration of particulate substances, of the reality space, and
the control information is information for controlling at least one of the concentration of carbon dioxide, the concentration of total volatile organic compounds, or the concentration of particulate substances, of the reality space.

10. The display apparatus according to claim 4, wherein
the state acquiring part acquires a concentration of carbon monoxide of the reality space,
the state information is warning information representing that the state of the reality space is in an abnormal state, and
the display part displays, when the concentration of carbon monoxide exceeds a threshold concentration, the warning information in the virtual space.

11. The display apparatus according to claim 5, wherein
the state acquiring part acquires a concentration of carbon monoxide of the reality space,
the state information is warning information representing that the state of the reality space is in an abnormal state, and
the display part displays, when the concentration of carbon monoxide exceeds a threshold concentration, the warning information in the virtual space.

12. The display apparatus according to claim 1,
further comprising a distance acquiring part which acquires a distance between a sound generation source of the sound acquired by the sound acquiring part and the display part, wherein
the display part displays, when the distance acquired by the distance acquiring part exceeds a threshold distance, in the virtual space, information that the sound is being generated.

13. The display apparatus according to claim 1, wherein the state information includes at least one of information representing a visitor to the reality space, information representing a state of an accepting part which accepts a delivery item for the reality space, or order information for a supplier who supplies a supply item to the operator.

14. The display apparatus according to claim 2, wherein the state information includes at least one of information representing a visitor to the reality space, information representing a state of an accepting part which accepts a delivery item for the reality space, or order information for a supplier who supplies a supply item to the operator.

15. A display method, comprising:
firstly displaying, by a display part, an image of a virtual space, and state information relating to a state of a reality space where an operator of the display part is present;
transmitting, by a transmitting part, to control equipment which is arranged in the reality space and controls the state of the reality space, control information for controlling the state of the reality space;
acquiring, by a sound acquiring part, a sound in the reality space;
identifying, by an identification part, whether the sound acquired in the acquiring the sound is a sound in the virtual space or a sound in the reality space; and
if the sound is identified as the sound in the reality space in the identifying, secondly displaying in the virtual space, by the display part, information that the sound is being generated.

16. The display method according to claim 15, further comprising:
thirdly further displaying, by the display part, a virtual input image in the virtual space; and
sensing, by a sensing part, input to the virtual input image, wherein
the transmitting transmits, by the transmitting part, when the input to the virtual input image is sensed in the sensing, the control information to the control equipment.

17. The display method according to claim 16, further comprising:
acquiring, by a state acquiring part, the state of the reality space, and
receiving, by a receiving part, the state of the reality space acquired in the acquiring the state.

18. The display method according to claim 15, further comprising
acquiring, by a distance acquiring part, a distance between a sound generation source of the sound acquired in the acquiring the sound and the display part, wherein
when the distance acquired in the acquiring the distance exceeds a threshold distance, in the secondly displaying, the display part displays, in the virtual space, information that the sound is being generated.

19. The display method according to claim 15, wherein the state information includes at least one of information representing a visitor to the reality space, information representing a state of an accepting part which accepts a delivery item for the reality space, or order information for a supplier who supplies a supply item to the operator.

20. A computer readable medium having recorded thereon a display program which causes, when being executed by a computer, the computer to execute:
firstly displaying an image of a virtual space, and state information relating to a state of a reality space where an operator of a display part is present;
transmitting, to control equipment which is arranged in the reality space and controls the state of the reality space, control information for controlling the state of the reality space;
acquiring a sound in the reality space;
identifying whether the sound acquired in the acquiring the sound is a sound in the virtual space or a sound in the reality space; and
if the sound is identified as the sound in the reality space by the identifying, secondly displaying in the virtual space, information that the sound is being generated.
